(19) United States
(12) Patent Application Publication
(10) Pub. No.: US 2004/0035240 A1
(43) Pub. Date: Feb. 26, 2004

(54) Gear stick handle having massage effect

(76) Inventor: Tieh-Cheng Shu, Taipei (TW)

Correspondence Address: Tieh-Cheng Shu, 235 Chung-Ho, Box 8-24, Taipei, TW

(21) Appl. No.: 10/223,736

(22) Filed: Aug. 20, 2002

(51) Int. Cl. G05G 1/04

(52) U.S. Cl. 74/523

(57) ABSTRACT

A gear stick handle having massage effect is disclosed. The gear stick handle has a gear stick head which is formed with a plurality of grooves. Each groove is installed with steel balls. Each steel ball is embedded into one of the plurality of groove by a seat placing between the steel ball and the groove. A top of the seat is formed with a thin lip edge for buckling the steel ball. The height of the seat is slightly higher than the radius of the steel ball and is equal to the height of the groove. Thereby, the steel ball is confined in the seat; an upper half of the steel ball is protruded from the seat and rotates upon the seat. A driver's palm drives the steel ball to rotate when the driver holds the gear stick head; thereby, the palm is massaged.

### BACKGROUND OF THE INVENTION

The present invention relates to gear stick head, and particularly to a gear stick handle having massage effect so that the driver will not doze off during driving.

The prior art gear stick head is formed integrally and has a smooth surface. Thereby, when the user's hand holds the gear stick head, no stimulation applies on the palm of the user. It is possible that the driver will doze off during driving so that an accident occurs.

Accordingly, the primary object of the present invention is to provide a gear stick handle having massage effect. The gear stick handle has a gear stick head which is formed with a plurality of grooves. Each groove is installed with steel balls. Each steel ball is embedded into one of the plurality of groove by a seat placing between the steel ball and the groove. A top of the seat is formed with a thin lip edge for buckling the steel ball. The height of the seat is slightly higher than the radius of the steel ball and is equal to the height of the groove. Thereby, the steel ball is confined in the seat; an upper half of the steel ball is protruded from the seat and rotates upon the seat. When driver's palm drives the steel ball to rotate when the driver holds the gear stick head; thereby, the palm is massaged.

Another object of the present invention is to provide a gear stick handle having massage effect. The gear stick handle having a gear stick handle. The gear stick head is formed by an upper half and a lower half. The upper half is firmly secured to the gear stick handle and the lower half is locked to the upper half. The upper half is installed with a plurality of grooves. Each groove is preset with a seat; and each seat is placed with a steel ball. A plurality of decorating holes are formed between the steel balls. Two opposite decorating holes are formed with penetrating holes. A portion at the lower half matched to the penetrating hole is installed with a respective screw hole. A stud enters into the penetrating hole of the upper half to the screw hole of the lower half. Thereby, the upper half and lower half are locked as a gear stick head.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is an assembled perspective view of the present invention.

FIGS. 3A/3B is a plane cross sectional view of the present invention.

FIG. 4 is an exploded perspective view of another embodiment of the present invention.

FIG. 5 is a plane cross sectional view of another embodiment of the present invention.

FIG. 6 shows one embodiment that a spring is added to the groove.

FIG. 6A is a partial enlarged view of FIG. 6.

FIG. 7 shows one embodiment of another gear stick head according to the present invention.

### DETAILED DESCRIPTION OF THE PREFERRED EMBODIMENTS

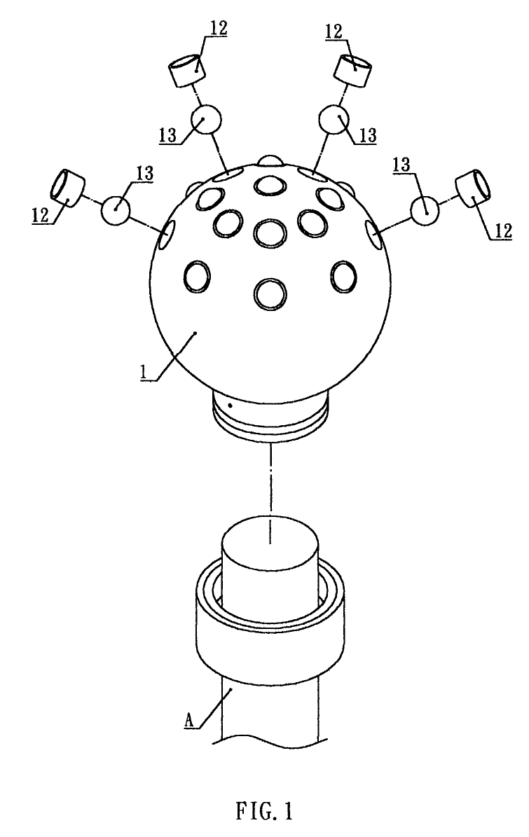

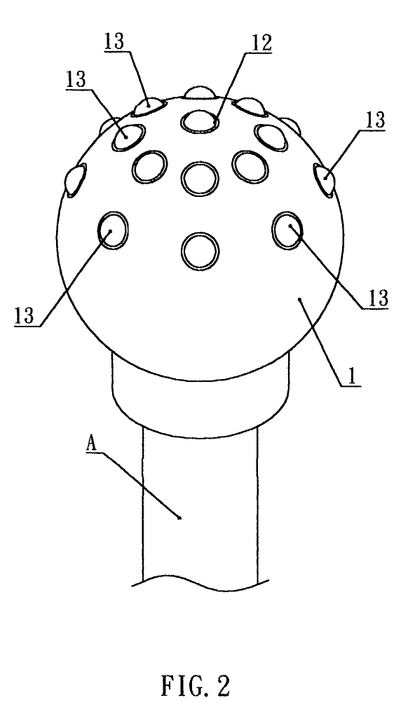

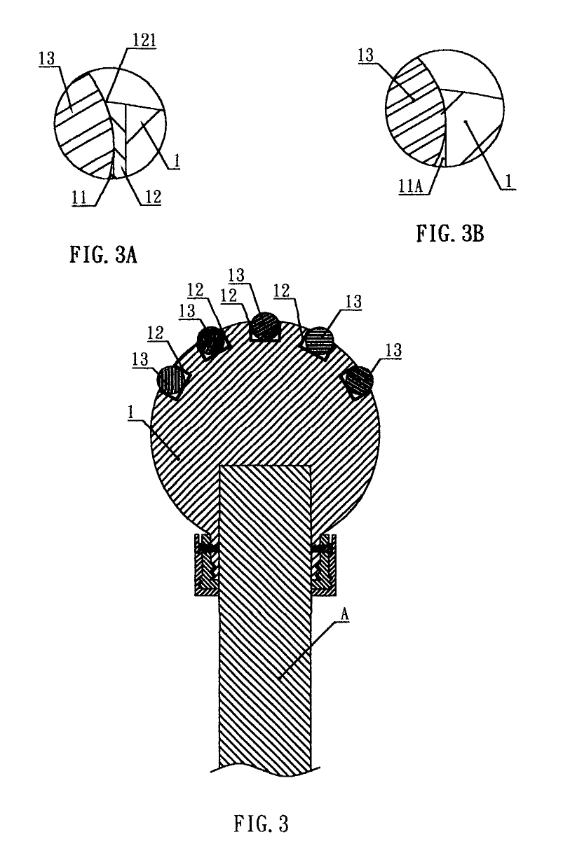

Referring to FIGS. 1 to 3, the structure of the present invention is clearly shown. In the present invention, the gear stick head 1 of a gear stick handle A is formed with a plurality of grooves 11. Each groove 11 is installed with steel balls. Each steel ball is embedded into a groove 11 by a seat 12. The top of the seat 12 is formed with a thin lip edge 121 for buckling the steel ball 13 (referring to FIG. 3A). The height of the seat 12 is slightly higher than the radius of the steel ball 13 and is equal to the height of the groove 11. Thereby, the steel ball 13 can be confined in the seat 12. The upper half of the steel ball 13 can be protruded from the seat 12 and rotates upon the seat. Moreover, the top of the gear stick head can be directly installed with a groove 11A with a lip edge for confining a steel ball 13 (referring to FIG. 3B).

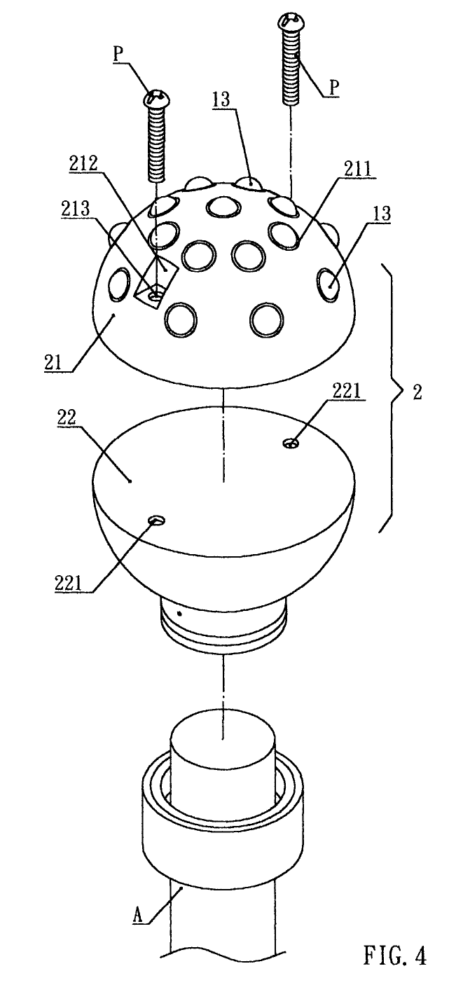

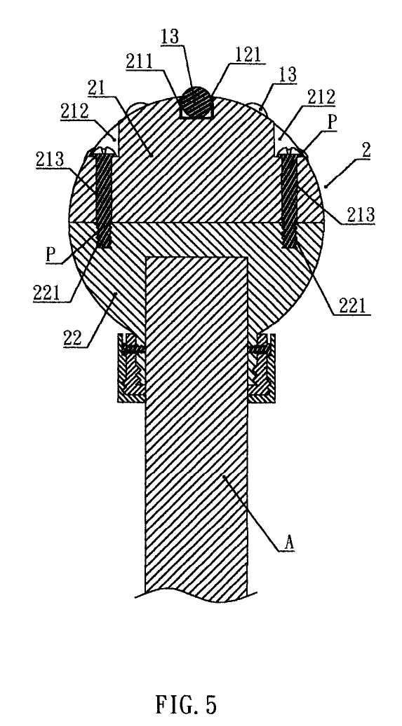

The gear stick head 1 is embedded with a plurality of rotatable steel balls 13. The driver's palm can drive the steel ball 13 to rotate when the driver holds the gear stick head. Thereby, the palm is massaged. Referring to FIGS. 4 and 5, another embodiment of the present invention is illustrated. The gear stick head 2 is formed by an upper half 21 and a lower half 22. The upper half 21 is firmly secured to the gear stick handle A and the lower half 22 is locked to the upper half 21. The upper half 21 is formed with a plurality of grooves 211. Each groove 211 is preset with a seat 12. Each seat 12 is placed with a steel ball 13. A plurality of decorating holes 212 are formed between the steel balls 12. Two opposite decorating holes 212 are formed with penetrating holes 213. A portion at the lower half 22 matched to the penetrating hole 213 is installed with a respective screw hole 221. The stud P enters into the penetrating hole 213 of the upper half 21 to the screw hole 221 of the lower half 22. Thereby, the upper half 21 and lower half 22 are locked as a gear stick head 2.

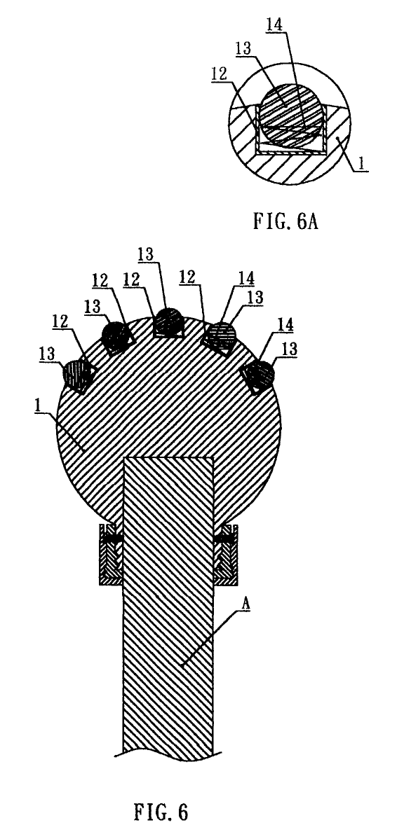

Referring to FIG. 6, another embodiment of the present invention is illustrated. The groove 11/211 of the gear stick head 1 is placed with a spring 14. An upper end of the spring 14 is placed with a steel ball 13 and a seat 12. Thereby, a spring 14 is placed between the steel ball 13 and the groove 11/211 so that when the steel ball 13 rotates, it will not be buckled in the groove 11.

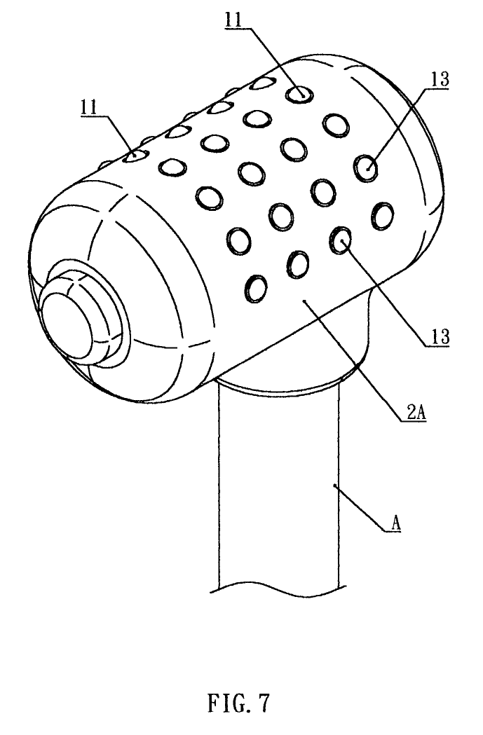

Further referring to FIG. 7, the gear stick head 2A has a round head.

By the gear stick head 2 forming by the upper half 21 and the lower half 22, by detaching the stud P, the upper half 21 can be separated so that the upper half 21 can be changed as desired.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A gear stick handle having massage effect; the gear stick handle having a gear stick head; characterized in that: the gear stick head is formed with a plurality of grooves; each groove is installed with steel balls; each steel ball is embedded into one of the plurality of grooves by a seat placing between the steel ball and the groove; a top of the seat is formed with a thin lip edge for buckling the steel ball; a height of the seat is slightly higher than the radius of the steel ball and is equal to the height of the groove; thereby, the steel ball is confined in the seat; an upper half of the steel ball is protruded from the seat and rotates upon the seat;
thereby, when driver's palm holds the gear change rod head and drives the steel ball to rotate, the palm is massaged.

2. The gear stick handle having massage effect; the gear stick handle having a gear stick head; characterized in that:
the gear stick head being formed by an upper half and a lower half; the upper half being firmly secured to the gear stick handle and the lower half is locked to the upper half; the upper half is formed with a plurality of grooves; each groove is preset with a seat; each seat is placed with a steel ball; a plurality of decorating holes are formed between the steel balls; two opposite decorating holes are formed with penetrating holes; a portion at the lower half matched to the penetrating hole is installed with a respective screw hole; a stud enters into the penetrating hole of the upper half to the screw hole of the lower half; thereby, the upper half and lower half are locked as a gear stick head;
wherein by detaching the stud, the upper half can be detached, thereby, the upper half is updateable.

3. The gear stick handle having massage effect as claimed in claim 1, wherein a top of the groove is punched with a lip edge for confining the steel ball.

4. The gear stick handle having massage effect as claimed in claim 2, wherein a top of the groove is punched with a lip edge for confining the steel ball.

5. The gear stick handle having massage effect as claimed in claim 1, wherein a spring is placed between a bottom of the seat and the steel ball, thereby, the steel ball will not be buckled when the steel ball rotates.

6. The gear stick handle having massage effect as claimed in claim 2, wherein a spring is placed between a bottom of the seat and the steel ball, thereby, the steel ball will not be buckled when the steel ball rotates.
